(19) United States
(12) Patent Application Publication
(10) Pub. No.: US 2012/0242995 A1
(43) Pub. Date: Sep. 27, 2012

(54) PATTERN INSPECTION APPARATUS AND PATTERN INSPECTION METHOD

(75) Inventors: Yusaku KONNO, Yokohama-Shi (JP); Naotada OKADA, Yokohama-Shi (JP); Shinichi IMAI, Tokyo (JP); Takayoshi FUJII, Yokohama-Shi (JP); Mitsutoshi WATABIKI, Yokkaichi-Shi (JP); Makoto KANEKO, Yokkaichi-Shi (JP); Yuichiro YAMAZAKI, Yokkaichi-Shi (JP); Yusuke IIDA, Yokkaichi-Shi (JP)

(73) Assignee: Kabushiki Kaisha Toshiba, Tokyo (JP)

(21) Appl. No.: 13/423,877

(22) Filed: Mar. 19, 2012

(30) Foreign Application Priority Data
Mar. 25, 2011 (JP) 2011-068443

(51) Int. Cl. G01B 9/02

(52) U.S. Cl. 356/450

(57) ABSTRACT

In accordance with an embodiment, a pattern inspection apparatus includes a beam splitter, a polarization controller, a phase controller, a wave front distribution controller, and a detector. The beam splitter generates signal light and reference light from light emitted from a light source. The signal light is reflected light from a pattern on a subject to be inspected. The polarization controller is configured to control the polarization angle and polarization phase of the reference light. The phase controller is configured to control the phase of the reference light. The wave front distribution controller is configured to control a wave front distribution of the reference light. The detector is configured to detect light resulting from interference caused by superposing the signal light and the reference light on each other.

### CROSS REFERENCE TO RELATED APPLICATIONS

This application is based upon and claims the benefit of priority from the prior Japanese Patent Application No. 2011-068443, filed on Mar. 25, 2011, the entire contents of which are incorporated herein by reference.

### FIELD

Embodiments described herein relate generally to a pattern inspection apparatus and a pattern inspection method.

### BACKGROUND

In the fields of semiconductor devices, flat panel displays, and micro electro mechanical systems (MEMS), a structure having micro patterns formed on its surface (hereinafter referred to as a “microstructure”) is manufactured, for example, by lithographic technology. In recent years, such microstructures have been miniaturized and increased in integration, and patterns formed on the surface have been increasingly fine.

Along with the patterns that have been increasingly fine, defects generated in manufacturing processes have also been increasingly small. In this case, if the size of a defect is small as compared with the wavelength of illumination light, the amount of scattered light from the defect is reduced. Therefore, the difference of reflectance dependent on the presence of a defect is smaller, and contrast is reduced accordingly.

### BRIEF DESCRIPTION OF THE DRAWINGS

FIG. 1A is a schematic diagram illustrating a pattern inspection apparatus according to a first embodiment;

FIG. 1B is a schematic diagram illustrating a MEMS mirror as an example of a wave front distribution controller;

FIG. 1C is a schematic diagram showing an example of an optimum wave front distribution obtained from a reference pattern;

FIG. 2 is a schematic diagram illustrating a pattern inspection apparatus according to a comparative example;

FIG. 3 is a schematic diagram illustrating a liquid crystal board LCB as an another example of a wave front distribution controller;

FIG. 4 is a schematic diagram illustrating rewritable holographic optical element (HOE) as an another example of a wave front distribution controller;

FIGS. 5A and 5B are graphs illustrating examples of advantageous effects according to the pattern inspection apparatus illustrated in FIG. 1A;

FIG. 6 is a schematic diagram illustrating a modification of the pattern inspection apparatus illustrated in FIG. 1A;

FIG. 7 is a flowchart illustrating a pattern inspection method according to a first embodiment;

FIG. 8 is a schematic diagram illustrating a pattern inspection apparatus according to a second embodiment;

FIGS. 9A to 9C are schematic diagrams illustrating examples of inspection data according to the pattern inspection apparatus illustrated in FIG. 8;

FIGS. 10A and 10B are graphs illustrating examples of advantageous effects according to the pattern inspection apparatus illustrated in FIG. 8;

FIG. 11 is a flowchart illustrating a pattern inspection method according to the second embodiment;

FIG. 12 is a graph illustrating an example of the wavelength dependence of reflectance from a defect in the pattern inspection apparatus illustrated in FIG. 1A;

FIG. 13 is a schematic diagram illustrating a basic light source unit for generating a deep ultraviolet light; and

FIGS. 14A and 14B are schematic diagrams illustrating broadband light sources that use the basic light source units illustrated in FIG. 13.

### DETAILED DESCRIPTION

In accordance with an embodiment, a pattern inspection apparatus includes a beam splitter, a polarization controller, a phase controller, a wave front distribution controller, and a detector. The beam splitter generates signal light and reference light from light emitted from a light source. The signal light is reflected light from a pattern on a subject to be inspected. The polarization controller is configured to control the polarization angle and polarization phase of the reference light. The phase controller is configured to control the phase of the reference light. The wave front distribution controller is configured to control a wave front distribution of the reference light. The detector is configured to detect light resulting from interference caused by superposing the signal light and the reference light on each other.

Embodiments will now be explained with reference to the accompanying drawings. Like components are given like reference numbers throughout the drawings, and are not repeatedly described in detail accordingly.

### (1) First Embodiment

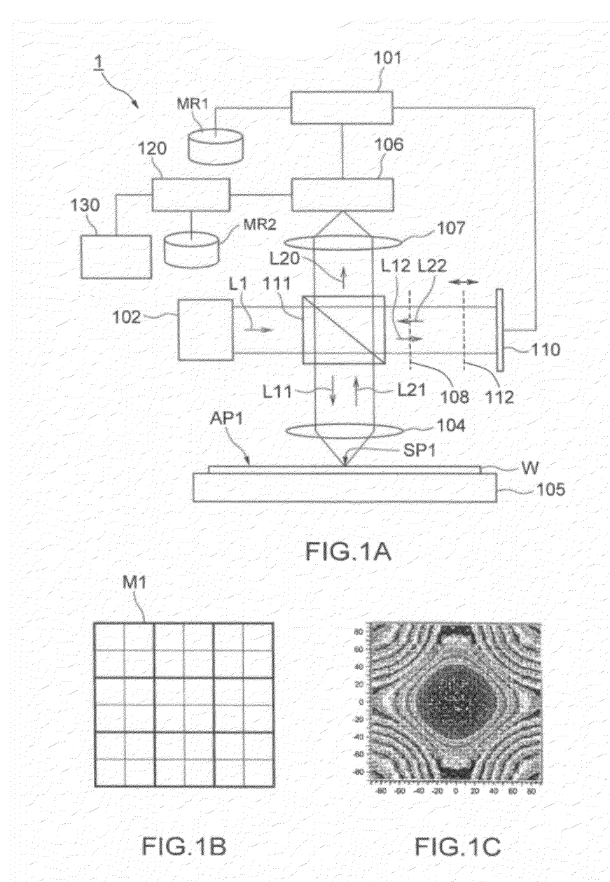

FIG. 1A is a schematic diagram illustrating a pattern inspection apparatus according to the first embodiment. FIG. 1B is a schematic diagram illustrating a MEMS mirror as an example of a wave front distribution controller. FIG. 1C is a schematic diagram showing an example of an optimum wave front distribution obtained from a reference pattern.

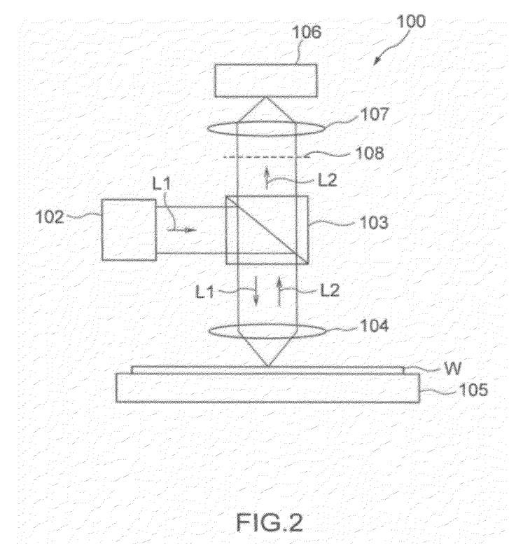

FIG. 2 is a schematic diagram illustrating a pattern inspection apparatus according to a comparative example.

First, the comparative example taken into consideration by the present inventor in the process of making the invention is explained.

As shown in FIG. 2, a pattern inspection apparatus 100 according to the comparative example is provided with a light source 102, a beam splitter 103, a mount 105, and a detector 106. On an optical path, an objective lens 104, an objective lens 107, and a polarization controller 108 are provided.

The light source 102 can emit coherent light. The beam splitter 103 reflects light L1 emitted from the light source 102, and guides the light to a wafer W in which an inspection target pattern is formed, and then transmits reflected light L2 from the pattern and guides the reflected light L2 to the detector 106. The wafer W is mounted on and held by the mount 105, and the mount 105 changes the position of the held wafer W. The mount 105 can be, for example, an XY table having an unshown electrostatic chuck. The detector 106 comprises, for example, an infrared charge coupled device (CCD) or a photomultiplier, and photoelectrically converts light of an image formed on a light-receiving surface. In the present embodiment, the wafer W corresponds to, for example, a substrate.

The objective lens 104 focuses the light L1 reflected by the beam splitter 103 on the inspection target pattern laid on the wafer W. The objective lens 107 focuses the reflected light L2 which has passed through the beam splitter 103 on the light-receiving surface of the detector 106. That is, the objective lens 107 forms an optical image of the inspection target on the light-receiving surface of the detector 106. The polarization controller 108 controls the polarization of the transmitted light (controls the polarization angle and polarization phase) so that the light will be linearly polarized light.

For example, a wavelength plate can be used as the polarization controller 108.

Now, the function of the pattern inspection apparatus 100 is explained.

First, the wafer W is mounted on and held by the mount 105 through an unshown conveyer or operator. The light L1 is then emitted from the light source 102. The light L1 emitted from the light source 102 is reflected by the beam splitter 103, and guided to the wafer W. At the same time, the light L1 is focused by the objective lens 104, and irradiates the inspection target pattern. The reflected light L2 from the pattern passes through the beam splitter 103, and the polarization of this light is controlled by the polarization controller 108. The reflected light L2 through the polarization control in the polarization controller 108 is focused on the light-receiving surface of the detector 106 by the objective lens 107. The optical image of the inspection target is formed on the light-receiving surface of the detector 106. Light of the optical image formed on the light-receiving surface of the detector 106 is photoelectrically converted to obtain inspection data. The position to conduct an inspection is then changed on the wafer W mounted on the mount 105, and inspection data in this position is acquired as described above. On the basis of the inspection data thus obtained, an inspection for defects is conducted. For example, the defect inspection is conducted by comparing the difference of light contrast between obtained inspection data.

In accordance with such a pattern inspection apparatus 100, a defect inspection can be conducted according to the difference of reflectance dependent on the presence of a defect. However, in recent years, patterns have been increasingly fine, and the size of a defect compared with the wavelength of illumination light has been increasingly small accordingly. Thus, the amount of scattered light from the defect has been reduced, and the difference of reflectance resulting from the presence of a defect has been increasingly small. As a result, contrast is reduced, and it may be difficult for the pattern inspection apparatus 100 to conduct a sufficient inspection for micro defects.

Now, a pattern inspection apparatus 1 according to the first embodiment is explained with reference to FIG. 1A.

As shown in FIG. 1A, a pattern inspection apparatus 1 according to the present embodiment is provided with a light source 102, a wave front distribution control signal generator 101, a beam splitter 111, a mount 105, a detector 106, an inspection data processor 120, a monitor 130, and a transmittance control element 110. On an optical path, an objective lens 104, an objective lens 107, a movable mirror (phase controller) 112, and a polarization controller 108 are provided.

The light source 102 is preferably capable of emitting light having a short wavelength. Such a light source includes, for example, a YAG laser light source which emits light having a wavelength of 266 nm. However, the light source is not exclusively the laser light source and can be changed suitably to, for example, the size of a pattern.

The beam splitter 111 splits light L1 emitted from the light source 102 into two optical paths. Light L11 reflected by the beam splitter 111 is guided to an inspection target pattern SP1 on a wafer W, and light L12 which has passed through the beam splitter 111 is guided to the transmittance control element 110. Reflected light L21 from the pattern SP1 and reflected light (hereinafter referred to as a “reference light”) L22 from the transmittance control element 110 are superposed on each other and can thereby interfere with each other.

The movable mirror 112 can move the position of a plane mirror in a direction parallel to an optical axis by an unshown driver. Thus, the length of the optical path can be changed by moving the position of the plane mirror, and the phase of the reference light L22 can be controlled.

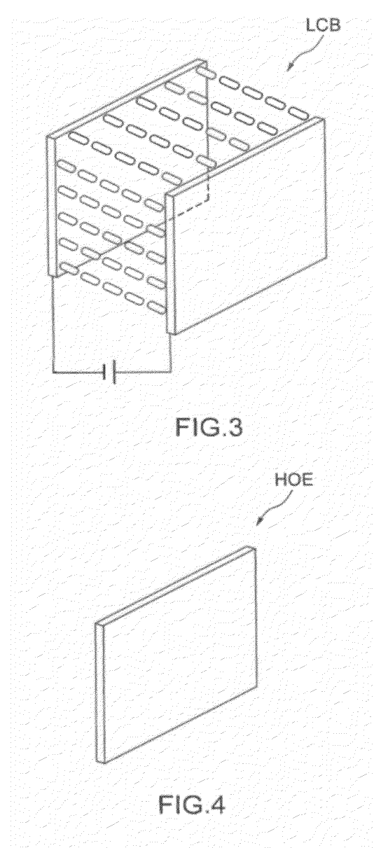

The transmittance control element 110 is configured so that the intensity and phase of the reference light can be partly selected, and the transmittance control element 110 can create a wave front distribution that minimizes noise according to a reference pattern for judging whether the inspection target pattern SP1 has any defect. Such a transmittance control element includes, for example, not only a two-dimensional MEMS mirror M1 illustrated in FIG. 1B but also a liquid crystal board LCB illustrated in FIG. 3, and a rewritable holographic optical element (HOE) illustrated in FIG. 4. A pattern having the same shape and size and made of the same material as the inspection target pattern SP1 is used as the reference pattern. For example, not only an alignment pattern AP1 shown in FIG. 1A but also a pattern that has been previously ascertained to be nondefective can be used. The reference pattern does not need to be laid on the wafer W, and may be formed on a substrate different from the wafer W.

Inspection data regarding an optical image of the reference pattern is provided to the wave front distribution control signal generator 101 from the detector 106. The wave front distribution control signal generator 101 thus generates a control signal for creating an optimum wave front distribution referring to a reference table stored in a memory MR1, and provides the control signal to the transmittance control element 110. An example of such an optimum wave front distribution is shown in FIG. 1C. The example in FIG. 1C illustrates a wave front distribution obtained when the alignment pattern AP1 is used as the reference pattern. The reference light whose wave front distribution is optimized is hereinafter referred to as the “optimized reference light”.

In the present embodiment, the transmittance control element 110 and the wave front distribution control signal generator 101 correspond to, for example, a wave front distribution controller, and the wave front distribution control signal generator 101 corresponds to, for example, a wave front adjuster.

Inspection data for the inspection target pattern is provided to the inspection data processor 120 from the detector 106. The inspection data processor 120 thus judges whether there is any defect, and displays a judgment result on the monitor 130 comprising, for example, a liquid crystal display. In the present embodiment, the detector 106 is located optically conjugate with the wafer W.

A memory MR2 stores two-dimensional position coordinate data for the inspection target pattern created for each wafer W by alignment using the alignment pattern AP1. The inspection data processor 120 specifies the position of a defect, if any, by referring to the two-dimensional position coordinate data in the memory MR2, and displays the position on the monitor 130.

Now, the function of the pattern inspection apparatus 1 is explained.

First, the wafer W is mounted on and held by the mount 105 through an unshown conveyer or operator.

A wave front distribution corresponding to the reference pattern is then created in the transmittance control element 110 as pre-processing.

First, the mount 105 is driven to move the wafer W so that the alignment pattern AP1 is brought into a field of view. Light L1 is then emitted from the light source 102. The light L1 emitted from the light source 102 is split by the beam splitter 111. Light L11 reflected by the beam splitter 111 is guided to the alignment pattern AP1 on the wafer W. In the meantime, light L12 which has passed through the beam splitter 111 is guided to the transmittance control element 110. At the same time, the light L11 is focused by the objective lens 104, and the polarization of the light L12 is controlled by the polarization controller 108. Reflected light L21 from the alignment pattern AP1 and reference light L22 from the transmittance control element 110 are superposed on each other in the beam splitter 111.

At the same time, the position of the plane mirror in the movable mirror 112 is controlled to change the length of the optical path. Thereby, the phase of the reflected light L22 is controlled so that the reflected light L21 and the reference light L22 interfere with each other. Light L20 (interfered light) is focused on the light-receiving surface of the detector 106 by the objective lens 107. Thus, an optical image of the inspection target enhanced in contrast by the interference is formed on the light-receiving surface of the detector 106. Light of the optical image formed on the light-receiving surface of the detector 106 is photoelectrically converted to obtain inspection data.

Furthermore, this inspection data is supplied to the wave front distribution control signal generator 101. Referring to the reference table stored in the memory MR1, the wave front distribution control signal generator 101 generates a control signal for creating an optimum wave front distribution, and provides the control signal to the transmittance control element 110. When the optimum wave front distribution is created, the intensity of the optical image formed on the light-receiving surface of the detector 106 is 0. Therefore, the wave front distribution control signal generator 101 generates control signals and provides the control signals to the transmittance control element 110 until a signal of the inspection data supplied from the detector 106 is 0.

When the optimum wave front distribution is thus created in the transmittance control element 110, the inspection target pattern SP1 is then inspected.

An inspection principle that uses the optimum wave front distribution in the transmittance control element 110 is explained.

First, the mount 105 is driven to move the wafer W so that the inspection target pattern SP1 is brought into the field of view. Light L1 is then emitted from the light source 102. The light L1 emitted from the light source 102 is split by the beam splitter 111. Light L11 reflected by the beam splitter 111 is guided to the inspection target pattern SP1 on the wafer W. In the meantime, light L12 which has passed through the beam splitter 111 is guided to the transmittance control element 110. At the same time, the light L11 is focused by the objective lens 104, and the polarization of the light L12 is controlled by the polarization controller 108. Reflected light L21 from the inspection target pattern SP1 and reference light L22 from the transmittance control element 110 are superposed on each other in the beam splitter 111.

At the same time, the position of the plane mirror in the movable mirror 112 is controlled to change the length of the optical path. Thereby, the phase of the reference light L22 is controlled so that the reflected light L21 and the reference light L22 interfere with each other by the superposition of the amplitude and phase. Light L20 (interfered light) is focused on the light-receiving surface of the detector 106 by the objective lens 107. Thus, an optical Image of the inspection target enhanced in contrast by the interference is formed on the light-receiving surface of the detector 106. Light of the optical image is photoelectrically converted to obtain inspection data.

Here, when the inspection target pattern SP1 has no defect, the intensity of the light focused on the light-receiving surface of the detector 106 is 0, and inspection data is also 0. When, on the other hand, the inspection target pattern SP1 has a defect, inspection data is obtained from the detector 106.

Under such an inspection principle, scanning is continuously or intermittently performed with the light L11 from the wafer W or the beam splitter 111 according to a desired inspection sequence. As a result, inspection data is acquired for a desired region on the wafer W, and the inspection data is sent from the detector 106 to the inspection data processor 120. The inspection data for the inspection target pattern is provided to the inspection data processor 120 from the detector 106, and the inspection data processor 120 compares the inspection data with a threshold which is prepared depending on the levels of the defect, and thereby judges whether there is any defect. The inspection data processor 120 specifies the position of a defect, if any, by referring to the two-dimensional position coordinate data stored in the memory MR2, and displays the position on the monitor 130. The inspection data processor 120 can also process the inspection data supplied from the detector 106, and generate a signal indicating the change of integrated intensity from an ideal pattern, a signal indicating the change of an intensity distribution, or a signal indicating the change of a phase distribution, and then displays the signal on the monitor 130.

The defect inspection is conducted by, for example, comparing the difference of light contrast between obtained inspection data.

Thus, in accordance with the present embodiment, first, contrast can be enhanced by causing the reflected light L21 and the optimized reference light L22 to interfere with each other. Moreover, in accordance with the present embodiment, a signal Indicating the change of integrated intensity from an ideal pattern, a signal indicating the change of an intensity distribution, or a signal indicating the change of a phase distribution is generated from the inspection data to inspect a pattern for a defect. Therefore, even when the inspection target pattern is repeatedly disposed with a period smaller than the wavelength of light L1 from the light source 102, a defect which is formed on the wafer and which is smaller than the wavelength of the light L1 can be detected. Thus, the contrast of a micro defect can be further enhanced independently of the kind of defect, its material, and its shape.

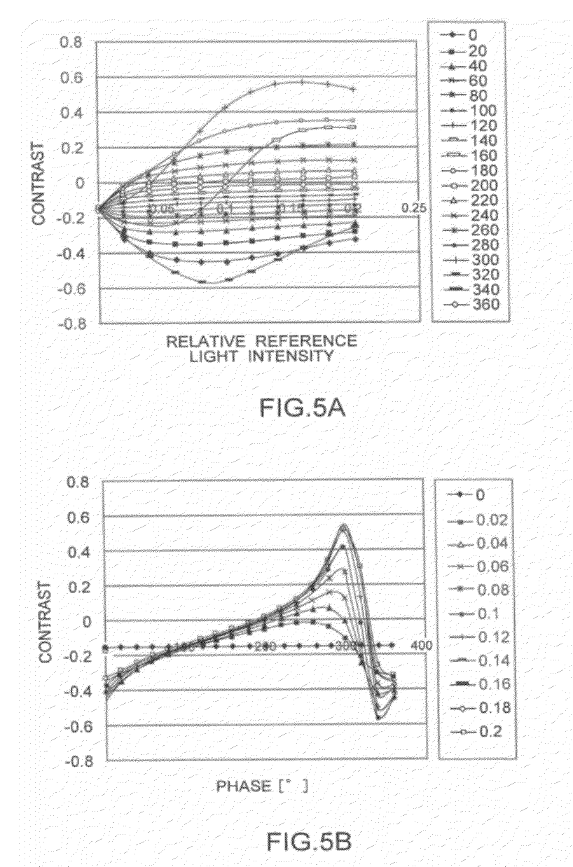

Advantageous effects according to the present embodiment are explained with reference to FIGS. 5A and 5B.

FIG. 5A and FIG. 5B are examples of graphs showing the relation between the intensity of the reference light, phase dependence, and contrast. FIG. 5A illustrates the relation between relative reference light intensity (the intensity of the reference light relative to the reflected light from the inspection target pattern) and contrast wherein the phase of the reference light is a parameter. FIG. 5B illustrates the relation between the phase of the reference light and contrast wherein the relative reference light intensity is a parameter.

From FIG. 5, the intensity of the reference light is 0 in the comparative example illustrated in FIG. 2, so that the contrast is 0.16 and lowest. On the other hand, in accordance with the present embodiment, it is found out that when the reference light relative intensity is 0.08 and the phase is 340°, the contrast is maximized (−0.56) by an opaque defect. When the reference light relative intensity is 0.16 and the phase is 300°, the contrast is maximized (0.56) by a clear defect. This proves that resolution is improved 3.75 times (0.56/0.16) as high as that of the comparative example.

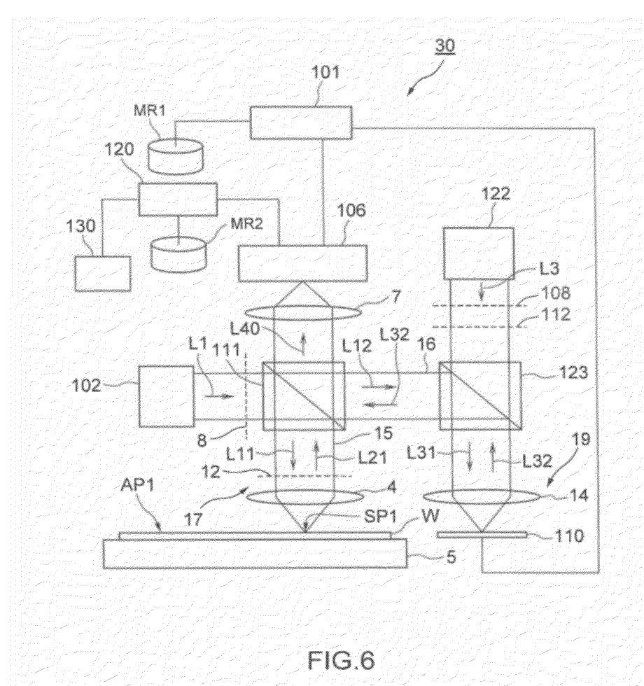

FIG. 6 is a schematic diagram illustrating a modification of the present embodiment. As apparent from the comparison with FIG. 1, a pattern inspection apparatus 30 illustrated in FIG. 6 is further provided with a light source 122 and a beam splitter 123. The beam splitter 123 transmits light L3 from the light source 122, and reflects light L12 which has passed through the beam splitter 111 and then guides the light L12 to the transmittance control element 110. A polarization controller 8 is disposed between the light source 102 and the beam splitter 111 to control so that the light L1 emitted from the light source 102 will be linearly polarized light. An irradiation controller 12 is disposed between the beam splitter 111 and an objective lens 4 to change the irradiation position of the light L11 so that the pattern SP1 on the wafer W can be irradiated thereby.

The polarization controller 8 controls the polarization (controls the polarization angle and polarization phase) of the light L1 emitted from the light source 102 so that the light will be linearly polarized light. Thus, the polarization controller 8 is provided on the optical path between the light source 102 and the beam splitter 111, and controls so that the light L1 emitted from the light source 102 will be linearly polarized light. The polarization controller 8 can be, for example, a wavelength plate.

The irradiation controller 12 changes the irradiation position of the light L11 so that the first pattern SP1 on the wafer W can be irradiated thereby. The irradiation controller 12 can be, for example, an acousto-optic modulator (AOM), a galvanometer mirror, or a polygon mirror. However, the irradiation controller 12 is not limited thereto, and any component that can change the light irradiation position can be suitably selected.

The configuration of the pattern inspection apparatus 30 is substantially the same as that of the pattern inspection apparatus 1 illustrated in FIG. 1 in other respects. The function of the pattern inspection apparatus 30 is also substantially the same as that of the pattern inspection apparatus 1 illustrated in FIG. 1 except that the light L1 and the light L3 are respectively emitted from the two light sources 102 and 122. Therefore, detail explanations are not given.

In accordance with the present modification, the light L1 emitted from the light source 102 and the light L3 emitted from the light source 122 are applied. As a result, the intensity of light used in an inspection can be enhanced, in addition to the advantageous effects described above in connection with the pattern inspection apparatus 1.

Now, a pattern inspection method according to the present embodiment is explained.

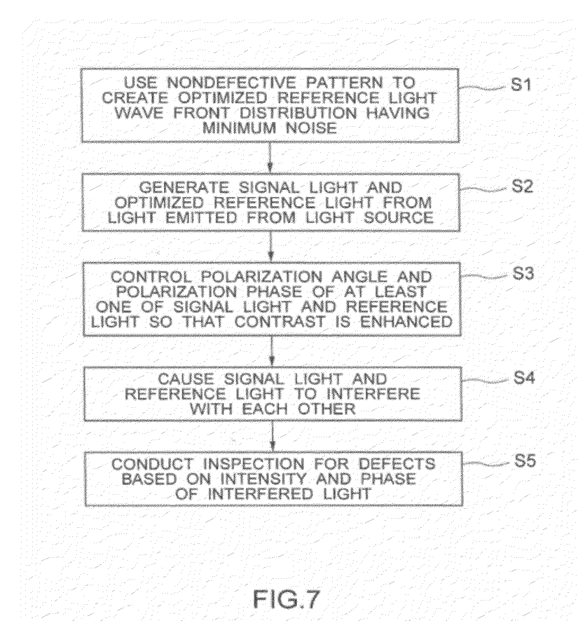

FIG. 7 is a flowchart illustrating the pattern inspection method according to the present embodiment.

First, the transmittance control element 110 uses a nondefective pattern to create an optimized reference light wave front distribution having the minimum noise (step S1).

Signal light and optimized reference light are then generated by light emitted from the light source (step S2). In this case, signal light and reference light may be generated by splitting light emitted from one light source into lights in two optical paths, as has been described with reference to FIG. 1. Alternatively, signal light and reference light may be generated by emitting lights from two light sources, as has been described with reference to FIG. 6.

Furthermore, the polarization angle and polarization phase of the signal light are controlled so that contrast is enhanced (step S3). In the case that light emitted from one light source is split into two optical paths, the polarization angle and polarization phase of the signal light can be controlled by controlling the polarization angle and polarization phase of the light before splitting into lights in two optical paths. On the other hand, when lights are emitted from two light sources, the polarization angles and polarization phases of the lights emitted from the light sources which generate signal light are controlled, and the polarization angle and polarization phase of the signal light can be thereby controlled.

Reflected light (signal light) from the pattern and the reference light are then caused to interfere with each other (step S4).

An inspection for defects is then conducted on the basis of the intensity and phase of the interfered light (step S5).

In accordance with this pattern inspection method, the signal light and the optimized reference light are caused to interfere with each other, and an inspection for defects is conducted on the basis of the intensity and phase of the interfered light. Thus, even a defect which is formed on the wafer and which is smaller than the wavelength of the light from the light source can be detected. The contrast of a micro defect can be further enhanced independently of the kind of defect, its material, and its shape. This allows an inspection for micro defects.

### (2) Second Embodiment

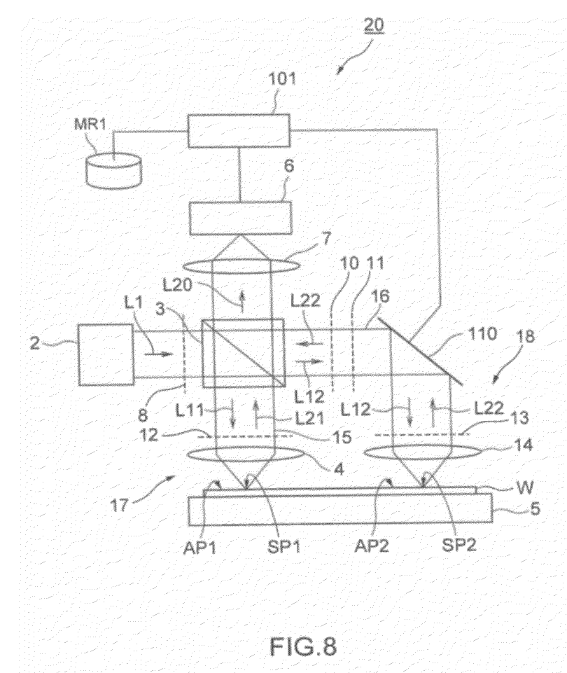

FIG. 8 is a schematic diagram illustrating a pattern inspection apparatus according to the second embodiment. A pattern inspection apparatus 20 shown in FIG. 8 is provided with a light source 2, a beam splitter 3, a mount 5, a detector 6, and a wave front distribution control signal generator 101. On an optical path, an objective lens 4, an objective lens 7, a polarization controller 8, a transmittance control element 110, a polarization controller 10, a phase controller 11, an irradiation controller 12, an irradiation controller 13, and an objective lens 14 are provided.

As in the case of the light source 102 in FIG. 1, for example, a YAG laser light source which emits light having a wavelength of 266 nm can be used as the light source 2.

The beam splitter 3 splits light L1 emitted from the light source 2 into a first light in a first optical path 15 and a second light in a second optical path 16. In this case, if the ratio of split intensity is 1:1, the first and second lights have the same intensity. Light L11 reflected by the beam splitter 3 is guided to a first pattern SP1 on a wafer W, and light L12 which has passed through the beam splitter 3 is guided to a second pattern SP2 on the wafer W via the transmittance control element 110. Reflected light L21 (signal light) from the first pattern SP1 on the wafer W and reflected light L22 (reference light) from the second pattern SP2 on the wafer W are superposed on each other and can thereby interfere with each other. The beam splitter 3 can be, for example, a half mirror.

The wafer W is mounted on and held by the mount 5. The mount 5 is provided with unshown moving means, and can change the position of the wafer W mounted on the mount 5 to move a region to be inspected. The mount 5 can be, for example, an XY table having an unshown electrostatic chuck. The mount 5 does not always need to be provided with any moving means, and it is only necessary that a region to be inspected be relatively changed.

The detector 6 photoelectrically converts light of an image formed on a light-receiving surface. Specifically, the detector 6 detects light L20 resulting from interference caused by superposing the reflected light L21 (signal light) and the reflected light L22 (reference light) on each other in the beam splitter 3. The detector 6 is disposed so that the light-receiving surface of the detector 6 is located optically conjugate with the surface in which the first pattern SP1 and the second pattern SP2 are formed. The detector 6 includes, for example, an infrared CCD or a photomultiplier. However, the detector 6 is not limited thereto, and any component that can photoelectrically convert light of a formed image can be suitably selected.

The objective lens 4 focuses the light L11 reflected by the beam splitter 3 on the first pattern SP1 laid on the wafer W.

The objective lens 14 focuses the light L12 which has passed through the beam splitter 3 on the second pattern SP2 on the wafer W. The objective lens 7 focuses the light L20 from the beam splitter 3 on the light-receiving surface of the detector 6. The objective lens 7 forms an optical image of the inspection target enhanced in contrast by the interference on the light-receiving surface of the detector 6.

The polarization controller 8 is provided on the optical path between the light source 2 and the beam splitter 3, and controls so that the light L1 emitted from the light source 2 will be linearly polarized light. The polarization controller 8 can be, for example, a wavelength plate.

The polarization controller 10 controls the polarization (controls the polarization angle and polarization phase) of the transmitted light.

The phase controller 11 controls the phase of the transmitted light. The phase controller 11 can be, for example, a light delay unit.

In this case, the polarization controller 10 controls so that the intensity of the reflected light L21 (signal light) may be substantially the same as the intensity of the reflected light L22 (reference light). The phase controller 11 controls the phase of the reflected light L22 (reference light) so as to be reverse to the phase of the reflected light L21 (signal light). Here, an inspection for micro defects is possible if the intensity of the reflected light L21 (signal light) differs by ±5% from the intensity of the reflected light L22 (reference light).

The polarization controller 10 and the phase controller 11 are provided on the second optical path 16 in FIG. 8, but can be provided on at least one of the first optical path 15 and the second optical path 16.

The transmittance control element 110 changes the traveling direction of the light L12 which has passed through the beam splitter 3, and thereby guides the light L12 to the second pattern SP2 on the wafer W. As in the first embodiment described above, the transmittance control element 110 is configured so that the intensity and phase of the light L12 can be partly selected, and the transmittance control element 110 can create a wave front distribution that minimizes noise according to a reference pattern for judging whether the inspection target patterns SP1 and SP2 have any defect.

For example, the two-dimensional MEMS mirror M1 Illustrated in FIG. 1B, the liquid crystal board LCB illustrated in FIG. 3, or the rewritable holographic optical element HOE illustrated in FIG. 4 can be used as the transmittance control element.

A pattern having the same shape and size and made of the same material as the inspection target patterns SP1 and SP2 is used as the reference pattern. For example, not only alignment patterns AP1 and AP2 formed on the wafer W but also a pattern that has been previously ascertained to be nondefective can be used. Also, the reference pattern does not need to be laid on the wafer W, and may be formed on a substrate different from the wafer W.

Inspection data regarding an optical image of the reference pattern is provided to the wave front distribution control signal generator 101 from the detector 6. The wave front distribution control signal generator 101 thus generates a control signal for creating an optimum wave front distribution, for example, illustrated in FIG. 1C by referring to a reference table stored in a memory MR1, and provides the control signal to the transmittance control element 110.

The irradiation controller 12 provided on the first optical path 15 changes the irradiation position of the light L11 so that the first pattern SP1 on the wafer W can be irradiated thereby. The irradiation controller 13 provided on the second optical path 16 changes the irradiation position of the light L12 so that the second pattern SP2 on the wafer W can be irradiated thereby. In this case, the irradiation position is changed so that the second pattern SP2 having the same shape and dimensions as the first pattern SP1 is irradiated. It is to be noted that the first pattern SP1 and the second pattern SP2 are not exclusively located in the same product as shown in FIG. 8, and may be located in different products. For example, in the case of a semiconductor device, the first pattern SP1 and the second pattern SP2 may be located in the same cell or chip (die), or may be located in cells or chips (dies) that are adjacent to each other or apart from each other by a predetermined dimension. The irradiation controller 12 and the irradiation controller 13 can be, for example, acousto-optic modulators (AOM), galvanometer mirrors, or polygon mirrors. However, the irradiation controller 12 and the irradiation controller 13 are not limited thereto, and any components that can change the light irradiation position can be suitably selected.

In the present embodiment, the objective lens 4 is provided on the first optical path 15, and serves as a first optical system 17 which guides the light L11 to the first pattern SP1 and also guides the reflected light L21 from the first pattern SP1. The transmittance control element 110 and the objective lens 4 are provided on the second optical path 16, and serve as a second optical system 18 which guides the light L12 to the second pattern SP2 having the same shape and dimensions as the first pattern SP1 and also guides the reflected light L22 from the second pattern SP2.

Now, the function of the pattern inspection apparatus 20 is explained.

First, the wafer W is mounted on and held by the mount 5 through an unshown conveyer or operator.

A wave front distribution corresponding to the reference pattern is then created in the transmittance control element 110 as pre-processing.

That is, the mount 5 is driven to move the wafer W so that the alignment patterns AP1 and AP2 are respectively brought into the field of view in the first optical path 15 and the second optical path 16. Light L1 is then emitted from the light source 2. The light L1 emitted from the light source 2 is controlled by the polarization controller 8 so that this light will be linearly polarized light. The light L1 controlled to be linearly polarized light is split by the beam splitter 3 into light L11 and light L12 so that, for example, the intensity ratio will be 1:1. The light L11 reflected by the beam splitter 3 is guided to the alignment pattern AP1 on the wafer W. In this case, the irradiation position is controlled by the irradiation controller 12 so that the inspection target pattern is irradiated, and the light L11 is focused by the objective lens 4.

On the other hand, the traveling direction of the light L12 which has passed through the beam splitter 3 is changed by the transmittance control element 110, and the light L12 is guided to the second alignment pattern AP2 on the wafer W. In this case, the irradiation position is controlled by the irradiation controller 13 so that the second alignment pattern AP2 having the same shape and dimensions as the first alignment pattern AP1 is irradiated. The light L12 is focused by the objective lens 14.

The polarization controller 10 controls the polarization (controls the polarization angle and polarization phase). The phase controller 11 controls the phase. In this case, the phase controller 11 controls the reflected light L22 (reference light) so that the reflected light L22 (reference light) may be substantially equal in intensity and reverse in phase to the reflected light L21 (signal light). An inspection for micro defects is possible if the intensity of the reflected light L21 (signal light) differs by ±5% from the intensity of the reflected light L22 (reference light).

The reflected light L21 (signal light) from the first alignment pattern AP1 and the reflected light L22 (reference light) from the second alignment pattern AP2 are superposed on each other in the beam splitter 3.

Interfered light reflected by the beam splitter 3 is focused on the light-receiving surface of the detector 6 by the objective lens 7. Light of the optical image formed on the light-receiving surface of the detector 6 is photoelectrically converted to obtain inspection data.

Furthermore, this inspection data is supplied to the wave front distribution control signal generator 101. Referring to the reference table stored in the memory MR1, the wave front distribution control signal generator 101 generates a control signal for creating an optimum wave front distribution, and provides the control signal to the transmittance control element 110. When the optimum wave front distribution is created, the intensity of the optical image formed on the light-receiving surface of the detector 6 is 0. Therefore, the wave front distribution control signal generator 101 generates control signals and provides the control signals to the transmittance control element 110 until a signal of the inspection data supplied from the detector 6 is 0.

When the optimum wave front distribution is thus created for the transmittance control element 110, the inspection target patterns SP1 and SP2 are then inspected.

Specifically, light L1 is emitted from the light source 2, and controlled by the polarization controller 8 so that this light will be linearly polarized light. The light L1 is split by the beam splitter 3 into light L11 and light L12 so that, for example, the intensity ratio will be 1:1. The light L11 reflected by the beam splitter 3 is guided to the first pattern SP1 on the wafer W. In this case, the irradiation position is controlled by the irradiation controller 12 so that the inspection target pattern is irradiated, and the light L11 is focused by the objective lens 4.

On the other hand, the traveling direction of the light L12 which has passed through the beam splitter 3 is changed by the transmittance control element 110, and the light L12 is guided to the second pattern SP2 on the wafer W. In this case, the irradiation position is controlled by the irradiation controller 13 so that the second pattern SP2 having the same shape and dimensions as the first pattern SP1 is irradiated. The light L12 is focused by the objective lens 14.

The polarization controller 10 controls the polarization (controls the polarization angle and polarization phase). The phase controller 11 controls the phase. In this case, the phase controller 11 controls the reflected light L22 (reference light) so that the reflected light L22 (reference light) may be substantially equal in intensity and reverse in phase to the reflected light L21 (signal light). An inspection for micro defects is possible if the intensity of the reflected light L21 (signal light) differs by ±5% from the intensity of the reflected light L22 (reference light).

The reflected light L21 (signal light) from the first pattern SP1 and the reflected light L22 (reference light) from the second pattern SP2 are superposed on each other in the beam splitter 3. In this case, the reflected light L21 (signal light) and the reflected light L22 (reference light) interfere with each other under the control of the polarization controller 10 and the phase controller 11 described above.

In this case, the reflected light L21 (signal light) and the reflected light L22 (reference light) are reverse in phase to each other. Therefore, when the first pattern SP1 is the same as the second pattern SP2, and when there is no defect, the intensity of superposed light L20 is significantly low. On the other hand, when the first pattern SP1 is partly different from the second pattern SP2, that is, when there is a defect, the intensity and phase of light changes in the defective part, so that the intensity of the superposed light L20 is high.

The superposed light L20 (interfered light) is focused on the light-receiving surface of the detector 106 by the objective lens 7. An optical image of the inspection target is thus formed on the light-receiving surface of the detector 106. Light of the optical image formed on the light-receiving surface of the detector 6 is photoelectrically converted to obtain inspection data.

When the position to conduct a next inspection is out of the range that can be irradiated by the irradiation controller 12 and the irradiation controller 13, the position of the wafer W is changed by the mount 5, and inspection data in this inspection position is acquired as described above. When the position to conduct a next inspection is within the range that can be irradiated by the irradiation controller 12 and the irradiation controller 13, the irradiation position is changed by the irradiation controller 12 and the irradiation controller 13, and inspection data in this inspection position is acquired as described above.

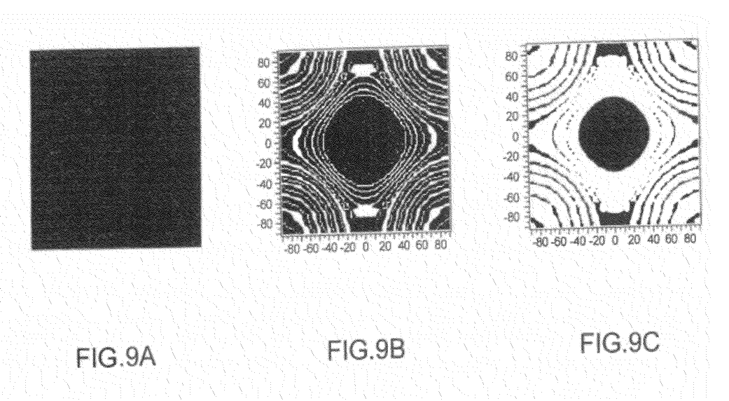

On the basis of the inspection data thus obtained, an inspection for defects is then conducted. For example, a defect can be identified by analyzing the difference of pupil plane distributions from the obtained inspection data. For example, when the first pattern SP1 is the same as the second pattern SP2, the intensity of the superposed light L20 is 0, as illustrated in FIG. 9A. The frequency band that allows lighting varies in the pupil plane distribution depending on the height of a defect as illustrated in FIG. 9B and FIG. 9C. Thus, the height of the defect can also be determined. In order to analyze the difference of pupil plane distributions of the interfered light, the interference can be compared with an ideal interference. The comparison includes, for example, amplitude comparison and phase comparison.

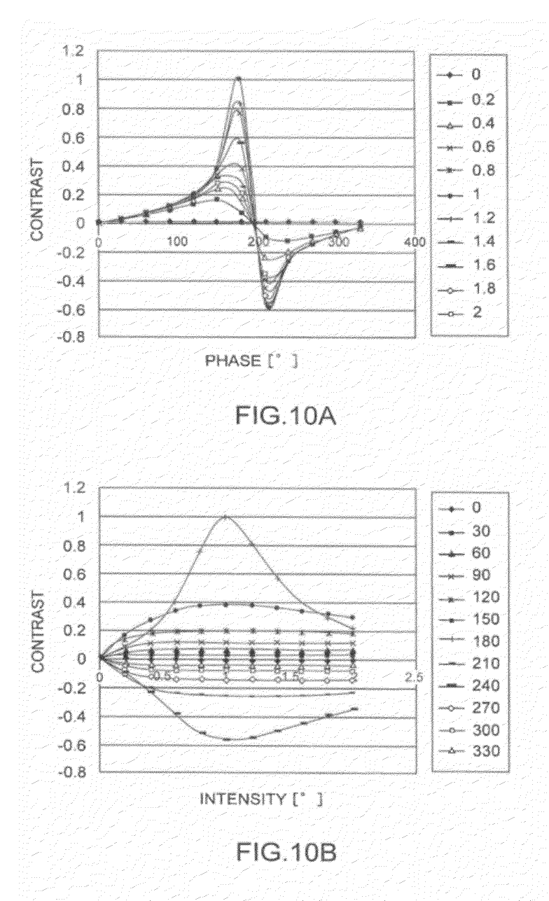

FIGS. 10A and 10B illustrate examples of the results of the simulation of advantageous effects according to the present embodiment. FIG. 10A shows an example of a simulation of the relation between the phase and contrast of the interfered light wherein the intensity of the interfered light is a parameter. FIG. 10B shows an example of a simulation of the relation between the intensity and contrast of the interfered light wherein the phase of the interfered light is a parameter. It is obvious form FIGS. 10A and 10B that the contrast is −0.6 when the phase of the interfered light having an intensity of 1 is 210 and that an ideal contrast of 1 is reached when the phase of the interfered light having an intensity of 1 is 180.

In accordance with the present embodiment, the reflected light L21 (signal light) and the reflected light L22 (reference light) can be caused to interfere with each other, so that the contrast can be enhanced. In this case, the reflected light L22 (reference light) originates from the second pattern SP2 having the same shape and dimensions as the first pattern SP1 which is the inspection target. This facilitates the control for causing the interference. Specifically, the reflected lights from the reflecting surfaces having the same characteristics are caused to interfere with each other, so that the phase and amplitude (light intensity) are easily controlled. Accordingly, contrast can be further enhanced, and an inspection for smaller defects can thus be conducted. Moreover, the transmittance control element 110 in which the optimum wave front distribution is previously created is disposed in the second optical system 18 to obtain the reference light. Therefore, a micro defect inspection can be conducted with high resolution independently of the kind of defect, its material, and its shape.

Now, another pattern inspection method according to the present embodiment is explained.

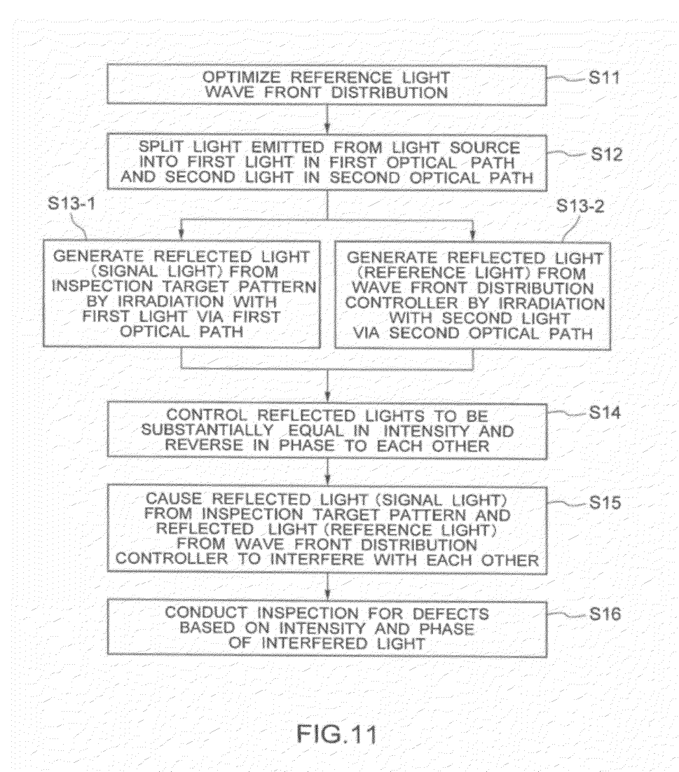

FIG. 11 is a flowchart illustrating another pattern inspection method according to the present embodiment.

First, the transmittance control element 110 uses a nondefective pattern to create an optimized wave front distribution having the minimum noise (step S11).

Light emitted from the light source is then split into a first light in the first optical path and a second light in the second optical path (step S12).

The first light is then applied to the first pattern SP1 as the inspection target via the first optical path to generate reflected light (signal light) from the first pattern SP1 (step S13-1).

The second light is also applied to the second pattern SP2 having the same shape and dimensions as the first pattern SP1 via the second optical path to generate reflected light (reference light) from the second pattern SP2 (step S13-2).

In this case, the second pattern SP2 can be a pattern that has been ascertained to be nondefective. Moreover, the first pattern SP1 can be formed on the wafer W, and the second pattern SP2 can be formed on a substrate W1 provided separately from the wafer W.

The reflected light (signal light) from the first pattern SP1 and the reflected light (reference light) from the second pattern SP2 are controlled to be substantially equal in intensity and reverse in phase to each other (step S14).

In this case, control for the intensity and phase can be conducted over the second light of the second pattern SP2. In addition, when, for example, a control value for the intensity and phase of the light is known in advance, previously controlled light can be applied to at least one of the first pattern SP1 and the second pattern SP2.

The reflected light (signal light) from the first pattern SP1 and the reflected light (reference light) from the second pattern SP2 are then caused to interfere with each other (step S15).

An inspection for defects is then conducted on the basis of the intensity and phase of the interfered light (step S16).

In accordance with the present embodiment, the reflected light (signal light) from the first pattern SP1 and the reflected light (reference light) from the second pattern SP2 can be caused to interfere with each other, so that the contrast can be enhanced. In this case, the reflected light (reference light) from the second pattern SP2 originates from the pattern having the same shape and dimensions as the first pattern SP1 which is the inspection target. This facilitates the control for causing the interference. Since the reflected lights from the reflecting surfaces having the same characteristics are caused to interfere with each other, the phase and amplitude (light intensity) are easily controlled.

Moreover, the transmittance control element 110 in which the optimum wave front distribution is previously created is disposed in the second optical system 18 to obtain the reference light. Therefore, a micro defect inspection can be conducted with high resolution independently of the kind of defect, its material, and its shape. Accordingly, contrast can be further enhanced, and an inspection for smaller defects can thus be conducted.

If a pattern that has been ascertained to be nondefective is used as the second pattern SP2, it is easily known that the first pattern SP1 is defective when the second pattern SP2 is judged to be defective in the inspection.

(3) Avoidance of Noise Caused by Film Thickness Unevenness of Thin Film

In a pattern inspection in which a pattern of a thin film is an inspection target, interference of light caused due to film thickness unevenness of the thin film results in noise. To avoid such a situation, it is desirable for a light source of the pattern inspection apparatus to have a wavelength width that can cancel the film thickness unevenness. More specifically, a light source having a wavelength width of ±several nm or above is desirable and, for example, a Ti:sapphire triple harmonic femto (10-15) second-order pulse laser having a wavelength of 260 nm±40 nm or below can be used to realize this light source.

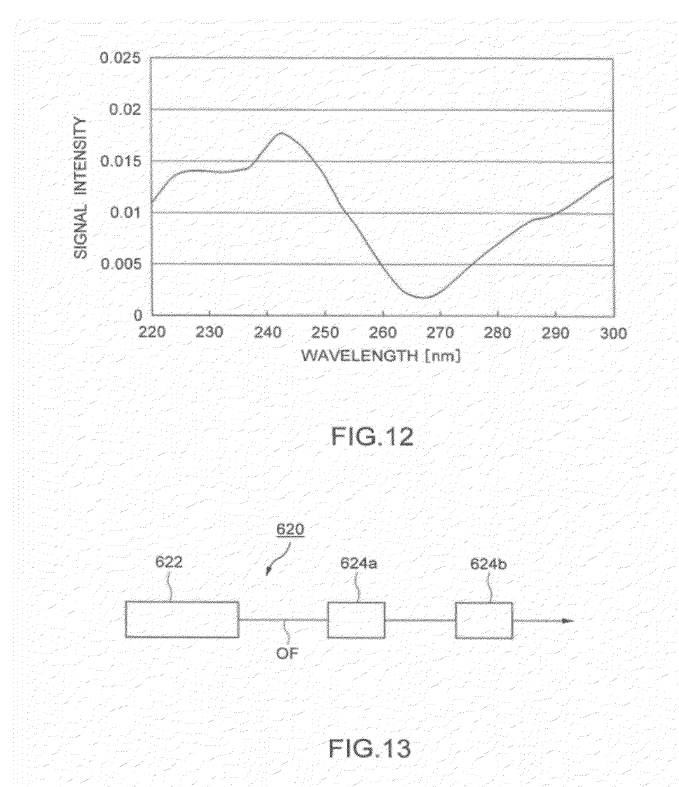

FIG. 12 is a graph in which the wavelength dependence of reflectance from a given defect is found by a simulation in the pattern inspection apparatus illustrated in FIG. 1A. Reflectance greatly changes with the wavelength due to influence of thin film interference. Therefore, in the example shown in FIG. 12, reflectance decreases in the vicinity of a wavelength of 260 nm. This proves that sufficient sensitivity is not obtained by the normal laser of a single wavelength. Accordingly, if a pulse laser light source having a wavelength of 260 nm±several ten nm is used as the light source 102 in the pattern inspection apparatus illustrated in FIG. 1A, An average of the integrated intensity of reflectance variation in FIG. 12 serves as signal intensity. This enables a robust pattern inspection to film fluctuation.

Moreover, a broadband light source constituted by coupling a plurality of lasers of different wavelengths with each other can be used in place of the pulse laser light source.

FIG. 13 is a schematic view showing a basic light source unit for generating deep ultraviolet light. A basic light source unit 620 depicted in FIG. 13 includes an infrared laser diode 622, and SHG (Second Harmonic Generation) elements 624a and 624b which are connected in series. The infrared laser diode 622 and the SHG element 624a are optically connected to each other through an optical fiber OF, and the SHG element 624a and the SHG element 624b are optically connected to each other through the same. The infrared laser diode 622 emits an infrared laser having a wavelength of 1064 nm±0.25 nm. A quadruple harmonic wave is generated from this infrared laser by the two SHG elements 624a and 624b, and deep ultraviolet light is output from the SHG element 624b.

The deep ultraviolet light output from the SHG element 624b has a wavelength width of approximately 266 nm±10 pm since a relationship between the wavelength and the wavelength width is as follows:

Δλ=Δλ266 nm×(λ266 nm×/λ1064 nm)²

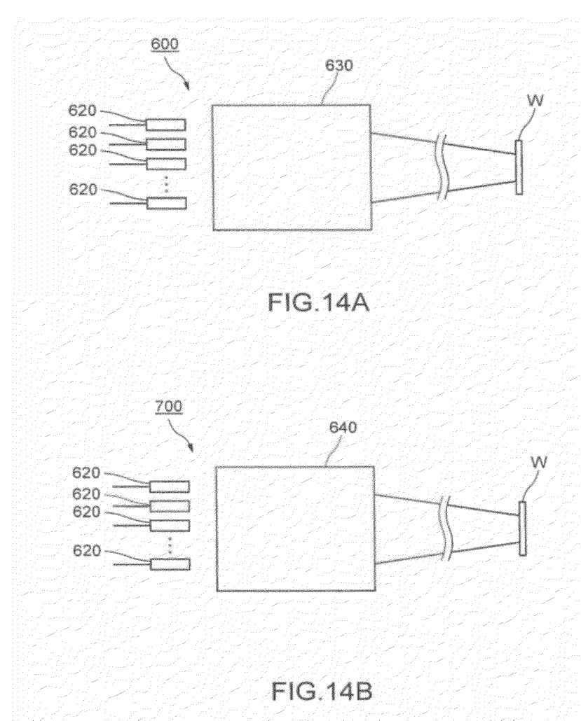

FIGS. 14A and 14B are schematic views showing broadband light sources constituted by using the plurality of basic light source units 620 depicted in FIG. 13.

A broadband light source 600 illustrated in FIG. 14A comprises 100 basic light source units 620 and a combiner 630. The central wavelengths of the basic light source units 620 are different from one another due to temperature control. Deep ultraviolet lights having different central wavelengths are combined together by the combiner 630 to obtain a light source of a desired wavelength width. The broadband light source 600 in this example makes it possible to obtain a light source having a wavelength width of ±1.5 nm. It should be understood that the light source is not limited to this wavelength width. A light source of a desired wavelength width can be obtained by controlling the central wavelength of the original emitted light of the infrared laser diode 622 and the number of the basic light source units 620.

A broadband light source 700 illustrated in FIG. 14B comprises 100 basic light source units 620 and a homogenizer 640. The homogenizer 640 homogenizes nonuniform light intensity distributions of the deep ultraviolet lights having different central wavelengths output from the 100 basic light source units 620. More specifically, as the homogenizer 640, it is possible to use arrayed lenses that bend light by refraction, and also use a diffractive optical element (DOE) to control a wave front by diffracted light. In the present embodiment, the homogenizer 640 corresponds to, for example, a wave front homogenizing optical system.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A pattern inspection apparatus comprising:
a beam splitter which generates signal light and reference light from light emitted from a light source, the signal light being reflected light from a pattern on a subject to be inspected;
a polarization controller configured to control the polarization angle and polarization phase of the reference light;
a phase controller configured to control the phase of the reference light;
a wave front distribution controller configured to control a wave front distribution of the reference light; and
a detector configured to detect light resulting from interference caused by superposing the signal light and the reference light on each other.

2. The apparatus of claim 1,
wherein the wave front distribution controller comprises a micro electro mechanical system (MEMS) mirror configured to partly select the intensity and phase of the reference light.

3. The apparatus of claim 2,
wherein the wave front distribution controller further comprises a wave front adjuster which previously adjusts the MEMS mirror prior to an inspection in such a manner that the intensity of an optical image formed by the interfered light on the detector is 0.

4. The apparatus of claim 1,
wherein the wave front distribution controller comprises a liquid crystal board configured to partly select the intensity and phase of the reference light.

5. The apparatus of claim 4,
wherein the wave front distribution controller further comprises a wave front adjuster which previously adjusts the liquid crystal board prior to an inspection in such a manner that the intensity of an optical image formed by the interfered light on the detector is 0.

6. The apparatus of claim 1,
wherein the wave front distribution controller comprises a holographic optical element configured to partly select the intensity and phase of the reference light.

7. The apparatus of claim 6,
wherein the holographic optical element is rewritable, and
the wave front distribution controller further comprises a wave front adjuster which previously adjusts the holographic optical element prior to an inspection in such a manner that the intensity of an optical image formed by the interfered light on the detector is 0.

8. The apparatus of claim 1,
wherein the phase controller controls the phase of the reference light so that the phase of the reference light and the phase of the reflected light are reverse to each other.

9. The apparatus of claim 1, further comprising:
a scanner which scans the subject with the signal light,
wherein the detector outputs a signal indicating change of integrated intensity from a reference pattern serving as a standard.

10. The apparatus of claim 1, further comprising:
a scanner which scans the subject with the signal light,
wherein the detector outputs a signal indicating change of an intensity distribution from a reference pattern serving as a standard.

11. The apparatus of claim 1, further comprising:
a scanner which scans the subject with the signal light,
wherein the detector outputs a signal indicating change of a phase distribution from a reference pattern serving as a standard.

12. The apparatus of claim 1,
wherein the pattern is repeatedly disposed with a period smaller than the wavelength of the light emitted from the light source.

13. The apparatus of claim 1,
wherein the light source emits a pulse laser having a wavelength width of 40 nm or below.

14. The apparatus of claim 1,
wherein the light source is a broadband light source configured to combine a plurality of lasers having central wavelength widths of ten pm or below and to emit the combined laser, the central wavelengths of the plurality of lasers being different from each other.

15. The apparatus of claim 14,
wherein the light source comprises a wave front homogenizing optical system which homogenizes light intensity distributions of the lasers.

16. The apparatus of claim 1, further comprising:
first and second light sources; and
first and second beam splitters corresponding to the first and second light sources, respectively.

17. A pattern inspection method comprising:
optimizing a wave front distribution of reference light by light emitted from a light source to a reference pattern;
generating signal light and the optimized reference light from the light emitted from the light source, the signal light being reflected light from a pattern on a subject;
superposing the signal light and the optimized reference light on each other to cause interference therebetween; and
inspecting a defect of the pattern on the basis of at least one of the intensity of the interfered light and a wave front distribution thereof.

18. The method of claim 17,
wherein conducting the inspection for the defect comprises generating a signal indicating change of integrated intensity, change of an intensity distribution, and change of a phase distribution, from data obtained by detecting the interfered light.

19. The method of claim 17,
wherein the reflected light and the reference light are controlled to be reverse In phase to each other.

20. A pattern inspection method comprising:
splitting light emitted from a light source into a first light in a first optical path and a second light in a second optical path;
applying the first light to a first pattern to be inspected via the first optical path to generate a first reflected light from the first pattern;
applying the second light to a second pattern having the same shape and dimensions as the first pattern via the second optical path to generate a second reflected light from the second pattern, a wave front distribution of the second reflected light being previously optimized by use of a reference pattern;
causing the first reflected light and the second reflected light to interfere with each other; and
inspecting a defect in the first pattern on the basis of the intensity of interfered light.
